(19) United States
(12) Patent Application Publication
(10) Pub. No.: US 2026/0365449 A1
(43) Pub. Date: Nov. 19, 2026

(54) AGGREGATE MATERIAL VIBRATING FEEDER APPARATUS

(71) Applicant: Portafill International Limited, Dungannon (GB)

(72) Inventor: Malachy James RAFFERTY, Omagh (GB)

(73) Assignee: Portafill International Limited, Dungannon (GB)

(21) Appl. No.: 19/240,597

(22) Filed: Jun. 17, 2025

(30) Foreign Application Priority Data
May 14, 2025 (GB) 2507420.4

(51) Int. Cl. B65G 47/44; B07B 1/40; B65G 11/12; B65G 27/04; B65G 27/12

(52) U.S. Cl. CPC B65G 47/44; B07B 1/40; B65G 11/126; B65G 27/04; B65G 27/12; B65G 2812/038; B65G 2812/0388

(57) ABSTRACT

An aggregate material vibrating feeder apparatus for receiving and conveying pre-processed aggregate material to an aggregate material processor, the feeder apparatus comprising a tray floor, an aggregate material discharge outlet, and a vibrating mechanism able to vibrate the apparatus to convey aggregate material along the tray floor towards the discharge outlet, wherein the tray floor comprises one or more ramped surfaces.

### CROSS REFERENCE TO RELATED APPLICATIONS

This application claims priority benefit from Great Britain Application No. 2507420.4 filed on May 14, 2025, entitled “Aggregate Material Vibrating Feeder Apparatus”, which is incorporated herein by reference in its entirety.

### BACKGROUND OF THE INVENTION

The present invention relates to an aggregate material vibrating feeder apparatus for receiving and conveying pre-processed aggregate material to an aggregate material processor, and an associated method. The present invention also relates to an aggregate material vibrating feeder assembly and to aggregate processing plants including the aggregate material vibrating feeder apparatus.

Aggregate material processors such as crushers are able to reduce various materials such as concrete, asphalt, rock, rubble and stone, into smaller sized materials. The smaller sized materials may be reusable, and therefore a valuable commodity product in their own right. Other aggregate material processors with screens can size or grade different sized materials, in particular deconstructed building materials, into different grades for stockpiling and/or reuse.

Such pre-processed aggregate material is typically provided into a feeder such as a hopper or the like as a mixture of materials, especially when provided as deconstructed material in a building site or the like. Such feeders typically consist of a tray or pan mounted on springs and actuated by a vibration unit such as an unbalanced motor or exciter. The resulting linear vibratory motion, generated by a combination of vertical and horizontal oscillations, causes materials to hop along the surface of the tray in a sawtooth-like throw trajectory towards a discharge end of the feeder, and then into or towards the aggregate material processor at the heart of the aggregate processing plant, such as the crushing jaws of a crusher or main separating screens. For expected engineering reasons, it would be desirable for the feeder to provide the most efficient material movement therealong, and an even or regular flow of material to the aggregate material processor.

However, such pre-processed aggregate material is typically provided into a feeder from another conveyor or from a bucket of a digger or excavator, thereby loading all incoming material into the feeder at one location. However, whilst the vibrations are intended to help smooth the flow of the pre-processed aggregate material along the length of the feeder towards the discharge end of the feeder, the actual rate of discharge is often still irregular and still a significant issue, especially where the pre-processed aggregate material is a mixture of materials of incompatible materials such as soil and brick, or wet or inconsistent feedstocks.

The present invention relates to an improvements in the art. There is also a need for a simple, modular, and field-adaptable arrangement that enables modification of a vibrating feeder tray to suit different material handling requirements without altering the underlying structure or the vibratory mechanism.

### SUMMARY OF THE INVENTION

According to one aspect of the present invention, there is provided an aggregate material vibrating feeder apparatus for receiving and conveying pre-processed aggregate material to an aggregate material processor, the feeder apparatus comprising a tray floor, an aggregate material discharge outlet, and a vibrating mechanism able to vibrate the apparatus to convey aggregate material along the tray floor towards the discharge outlet, wherein the tray floor comprises one or more ramped surfaces.

According to another aspect of the present invention, there is provided a method of receiving and conveying pre-processed aggregate material to an aggregate material processor using an aggregate material vibrating feeder apparatus, said apparatus comprising a tray floor comprising one or more ramped surfaces, an aggregate material discharge outlet, and a vibrating mechanism, the method comprising at least the steps of:
(a) providing pre-processed aggregate material to the aggregate material vibrating feeder apparatus;
(b) operating the vibrating mechanism to vibrate the apparatus and to convey aggregate material along and over the at least one ramped surface towards the discharge outlet.

According to another aspect of the present invention, there is provided an aggregate material vibrating feeder assembly comprising an aggregate material vibrating feeder apparatus as defined herein and an attached screening unit for screening the aggregate material provided by the aggregate material discharge outlet of the aggregate material vibrating feeder apparatus, the screening unit comprising a first grid of elongate fixed longitudinal bars, and a second grid of elongate moveable longitudinal bars interspaced with the fixed longitudinal bars, wherein the second grid is directly driven in use in an eccentric motion relative to the first grid.

According to another aspect of the present invention, there is provided an aggregate processing plant comprising a mobile chassis having a main frame and an aggregate material processor, wherein the feed for the aggregate material processor is provided by an aggregate material vibrating feeder apparatus as defined herein.

### BRIEF DESCRIPTION OF THE DRAWINGS

Embodiments of the present invention will now be described by way of example only and with reference to the accompanying drawings, in which:

FIG. 1 is a part-open view of an impact crusher according to an embodiment of the present invention;

FIG. 2 is a perspective view of a prior art hopper feeder;

FIG. 3 is a diagram of the working of the hopper feeder of FIG. 2;

FIGS. 4 and 5 are a side cross-sectional view and a perspective view respectively of an aggregate material vibrating feeder apparatus and aggregate material vibrating feeder assembly according to further embodiments of the present invention;

FIG. 6 is a perspective view of a ramp insert useable as part of the present invention; and

FIG. 7 is a cross-sectional view of the assembly of FIG. 5 showing a change in angle of attack.

### DETAILED DESCRIPTION OF THE INVENTION

The present invention relates to an aggregate material vibrating feeder apparatus for receiving and conveying pre-processed aggregate material to an aggregate material processor. Aggregate material processors include any units, apparatus or systems, generally intended to ‘process’ materials. One processing example is to reduce various materials such as concrete, asphalt, rock, rubble and stone, into smaller sized materials and/or to size or grade different sized materials, in particular quarry materials or deconstructed building materials, into different grades for stockpiling and/or reuse. Such processors include crushing apparatus such as jaw crushers, impact crushers, cone crushers, screening units such as ‘vibrating screening units’, feeder hopper systems for conveyors, separation and sorting units such as density separators and magnetic separators, and recycling units such as shredders. Such aggregate material processors can be used in for example in quarrying, recycling and demolition applications.

Aggregate material processors can be static. Optionally, the aggregate material processor is mobile, and is located on a mobile chassis, able to manoeuvre to different locations, particularly to different locations around a quarrying, recycling or demolition site. Typically, the mobile chassis has at least a main frame to which the aggregate material processor is secured, and one or more outward or discharge material conveyors.

The pre-processed aggregate material useable by the present invention includes any and all materials to be processed in quarrying, recycling and demolition applications. This can include concrete, asphalt, rock, rubble and stone, possibly mixed or fixed or otherwise intertwined together, possibly also intertwined with one or more other materials such as soil, dirt, earth, clay, mud, slit and the like. The purpose of the aggregate material processing is to provide and/or recover one or more streams of material that are useable or reuseable.

The pre-processed aggregate material is typically provided from a source near or on a site, via a conveyor or the bucket of a suitable excavator or digger. It is typically convenient to provide the pre-processed aggregate material into a feed hopper designed to feed the pre-processed aggregate material to the aggregate material processor from an suitable outlet in a suitable flow. Such flow is most conveniently in the form of being more regular or smooth than the often peripatetic or non-continuous flow of pre-processed aggregate material into the feed hopper.

A conventional feed hopper has a tray floor and upstanding sides, with a material outlet, typically at one end of the feed hopper. In order to help or induce material flow, the feed hopper is typically vibrated by a vibration unit such as an unbalanced motor or exciter. The resulting linear vibratory motion, generated by a combination of vertical and horizontal oscillations, causes materials to hop along the surface of the tray in a sawtooth-like throw trajectory towards a discharge end of the feeder.

The progress or trajectory of material along the tray floor can be based on the known parameters of the hopper and the vibration unit. But the trajectory, and therefore the effectiveness of material flow, can also be dependent on the angle of attack, that is the angle at which vibratory force is applied relative to the horizontal plane, generally the ground surface on which the apparatus including the feeder sits or rests. This is shown in FIG. 3 discussed hereinafter. Such a horizontal plane may not be the same as the angle of the tray floor, especially for feeders intended to be inclined relative to the ground surface.

The optimal angle of attack depends on several factors, including bulk density, particle size and shape, moisture content, flowability, etc. of the pre-processed aggregate material. In one known arrangement, the vibration unit provides an angled and forward ‘thrust’ at 35° to the base or level of the feed hopper tray, to make the material hop forwardly. Other angles of attack are known.

The flow of different pre-processed aggregate materials would be aided by different angles of attack. For example, a lower angle of attack could result in a slower, more controlled material movement, suitable for metering or fine feed control. However, in conventional apparatus, the angle of attack is fixed by the geometry of the feeder tray and the orientation of the vibration source. Modifying this angle requires mechanical reconfiguration, which is impractical for field use.

There is therefore a need for a simple, modular, and field-adaptable system that enables modification of the effective angle of attack on a vibrating feeder tray to suit different material handling requirements without altering the underlying structure or vibratory mechanism. For example, in applications where it is desirable to reduce the flow rate at specific locations along the tray, particularly at the discharge end, an insertable or easy to attach apparatus that enables targeted control of a particular material speed and behaviour would be highly beneficial.

The present invention provides an aggregate material vibrating feeder apparatus for receiving and conveying pre-processed aggregate material to an aggregate material processor, the feeder apparatus comprising a tray floor, an aggregate material discharge outlet, and a vibrating mechanism able to vibrate the apparatus to convey aggregate material along the tray floor towards the discharge outlet, wherein the tray floor comprises one or more ramped surfaces.

The one or more ramped surfaces have at least one surface inclined in the direction of flow of the pre-processed aggregate material along the feeder apparatus towards the discharge outlet, which enable alteration of the progress or trajectory of the pre-processed aggregate material along the feeder apparatus, (relative to a flat tray floor or a flat tray floor design). By changing the angle of tray floor relative to the angle of attack, i.e. the angle at which vibratory force from the vibrating mechanism is applied to the tray floor relative to a horizontal surface on which the feeder apparatus ultimately rests, typically the ground surface, a more consistent or regular volume and/or amount of material reaching the discharge outlet can be achieved.

In one embodiment of the present invention, the one or more ramped surfaces can decrease the effective angle of attack experienced by the material, thereby reducing material velocity and improving metering accuracy to the aggregate material processor. That is, as the ramped angle increases relative to the tray floor, the effective angle of attack experienced by the material decreases, resulting in slower and more controlled material movement. Such decrease may be at least 5° relative to the remainder of the tray floor angle. Such decrease may be or may not be constant.

The present invention therefore provides the user with apparatus, means, and a method of adapting material feed behaviour through a feeder apparatus such as a hopper, without altering the geometry or orientation of the feeder tray or the vibration mechanism.

The term ramped surface as used herein includes any surface having at least one inclined surface relative to a ‘flat surface on which the ramped surface is to be located, or to be applied. That is, a surface that changes the angle of a flow of material thereover relative to a conventional 'flat’ surface of a floor or tray. Such a conventional ‘flat’ floor or tray may already be inclined relative to a horizontal plane or reference frame, such as the ground surface on which the aggregate material processor sits or rests, but a ramped surface changes the floor angle from this ‘flat’ frame of reference.

The ramped surfaces may be of an suitable size, shape or design. Each ramped surface may be the same or different to other ramped surfaces, in dimensions such as height, width or any curvature, and may be symmetrical or asymmetrical relative to the tray floor, and may be in series or parallel or both relative to the flow path of material along the feeder apparatus. Each ramped surface may be continuous or comprises one or more differently inclined surfaces. For example, a ramped surface may comprise a variable inclined surface.

The or each ramped surface may include a majority portion forming a first longer surface changing the angle from a conventional level of the tray floor of the feeder apparatus, and a second surface forming a shorter second surface returning to another level, such as the tray floor or an intermediate height. Such ramped surfaces may comprise a ‘step’ of different proportional sides. Optionally, the one or more ramped surfaces form a series of steps along the path of the tray floor towards the discharge outlet. The steps may be regular or irregular, and may be consecutive or discrete.

Examples of ramped surfaces include ramps with different inclinations but the same ‘height’ relative to the tray floor, or ramps with different inclinations and different ‘heights’ relative to the tray floor, ramps with the same inclinations but different ‘heights’ relative to the tray floor, or convex ramps, or concave ramps, or ramps with a concave or convex initial curvature followed by a more angular flat plane, or a final concave or convex curvature after a more angular flat plane from the tray floor, or a ramp with both convex and concave curvatures, or any combination of same. The skilled user can seek a cross-sectional profile for a ramped surface to suit a particular trajectory of particular material.

In some embodiments, the ramped surfaces are discrete components that may be removably attached to the feeder tray, either individually, or as a complete insert or insert unit, each able to be inserted into the feeder apparatus. Optionally, the ramped surfaces include one or side wings orthogonal to the ramped surfaces, optionally to be complementary to any side walls, and generally to assist location and/or wear of the ramped surfaces.

In one particular embodiment, the ramped surfaces are formed as an insert, and the aggregate material feeder apparatus of the present invention comprises a tray floor and such an insert. Optionally, the insert has a base or frame, able to be secured to a tray floor, and one or more ramped surfaces which are either integral or changeable or both with the base or frame. Optionally, the insert is insertable into a conventional aggregate material feeder apparatus such as a conventional aggregate hopper.

In some embodiments, multiple ramped surfaces may be used, either with the same or differing inclination angles. These ramped surfaces may be interchangeable to allow adjustment of the angle of attack by replacing one ramp with another having a different geometry, depending on the aggregate material mixture or ‘type’ to be processed, or desired flow behaviour.

In another embodiment, the ramped surfaces may be permanently attached or otherwise integrated into the feeder tray. The tray or a tray insert may also be formed with a folded or welded profile with the one or more ramped surfaces, such that the effective angle of attack varies along the length of the tray.

The one or more ramped surfaces can allow for gradual or staged transitions in material velocity and trajectory as the material progresses along the tray. The present invention can also allow for local or distributed modification of the feed trajectory across specific regions of the tray. For example, a shallower ramp may be positioned near a feed or entry location or zone, with progressively steeper ramped surfaces toward the discharge outlet, to slow material. Such configurations allow more granular control of feed consistency and performance.

The present invention can also allow for local modification of the feed trajectory across specific regions of the tray. For example, a shallower ramp may be placed at the centreline for higher flow speeds, while steeper ramps are positioned at the sides for edge control. Such configurations allow more granular control of feed consistency and performance.

One embodiment of the present invention comprises the at least one ramped surface comprising two regularly shaped ramps in series, each ramp being the same or different height, and extending across the width of the feeder apparatus.

Optionally, the one or more of the ramped surfaces are formed by one or more ramps.

Optionally, the or each ramp is either integral with the tray floor, or is temporarily secured to the tray floor, or a combination of same.

Optionally, at least one ramped surface is located at or near the aggregate material discharge outlet.

Optionally, at least one ramped surface has an angle of inclination relative to the tray floor of between >0° and 60° over the length of the inclined part of the ramped surface. The angle of inclination could be for example 1°, 2°, 3°, 4°, 5°, 6°, 7°, 8°, 9°, 10° or higher. Optionally, at least one ramped surface has an angle of inclination relative to the tray floor of between 1° and 10°, such as 5°. For example, an angle of inclination of 5° would change an existing angle of attack of 30°, 35° or 40°, to an angle of attack of 25°, 30° or 35°.

The angle of inclination of the ramped surface may be wholly or substantially constant, optionally over a majority portion of the ramped surface. Optionally, each ramped surface has a constant angle of inclination relative to the tray floor. Optionally, ramped surface has the same cross-section. Optionally, each ramped surface has a different angle of inclination relative to the tray floor. Optionally, each ramped surface has a different same cross-section. Optionally, the change in angle of attack created by the or each ramped surface relates to the peak or height of the ramped surface, relative to the existing or conventional tray floor angle.

Optionally, the surface of at least one ramped surface includes a replaceable wear liner on at least its inclined surface.

Optionally, the aggregate material vibrating feeder apparatus further comprises one or more side walls. The one or more side walls may be integral with the tray floor, or be securely attached to the tray floor, or may be independent of the tray floor. In one example, the feeder apparatus has one or more integrated side walls that are structurally part of the feeder apparatus and move in unison with the tray floor. In another example, the one or more side walls are separate from the feeder apparatus, and optionally part of or fixed to a chassis or a surrounding frame, so that only the tray floor vibrates. In another example, a portion of a feeder apparatus may be static or fixed, i.e. non-vibratory, and only a short section of the one or more side walls near the discharge outlet vibrates with the tray floor.

Optionally, at least one, optionally all, of any one or more side walls are orthogonally inclined relative to the tray floor.

Optionally, the aggregate material vibrating feeder apparatus comprises two side walls either side of the tray floor, and at least two ramped surfaces extending across the width of the tray floor between side walls.

Optionally, the feeder apparatus is a hopper.

The feeder apparatus may have any suitable, size, shape or design.

Optionally, the tray floor is wholly or substantially elongate and flat, and the feeder apparatus further comprises two inclined side walls and a conjoined inclined end wall. Optionally, the aggregate material discharge outlet is wholly or substantially an end of the tray floor without any side wall. The tray floor may be inclined relative to a horizontal reference frame as discussed hereinbefore.

Optionally, the vibrating mechanism is an eccentric drive mechanism, able to apply an eccentric motion to the apparatus to convey aggregate material along the tray floor towards the discharge outlet.

Ramp structures may be fabricated from high-wear-resistant materials or composite layers with optional replaceable wear liners, providing durability in abrasive environments. When removable, the ramps may be fastened using mechanical fasteners and reconfigured using standard tools in the field.

The present invention also provides a method of receiving and conveying pre-processed aggregate material to an aggregate material processor using an aggregate material vibrating feeder apparatus, said apparatus comprising a tray floor comprising one or more ramped surfaces, an aggregate material discharge outlet, and a vibrating mechanism, the method comprising at least the steps of:
(a) providing pre-processed aggregate material to the aggregate material vibrating feeder apparatus;
(b) operating the vibrating mechanism to vibrate the apparatus and to convey aggregate material along and over the at least one ramped surface towards the discharge outlet.

Optionally, the method further comprises the step of securing one or more ramps to the tray floor to create the one or more ramped surfaces prior to step (a). Each of the one or more ramps may be permanently or temporarily, or a combination thereof, secured to the aggregate material vibrating feeder apparatus. Typically, such securement is to the tray floor. Such securement may be by welding, fixing means such as bolts et al.

Optionally, the method further comprises the step of modifying the tray floor to create the one or more ramped surfaces prior to step (a). The tray floor may be reshaped using suitable machinery.

The method of the present invention is able to reduce the velocity of the pre-processed aggregate material along the aggregate material vibrating feeder apparatus as discussed hereinabove.

The aggregate material vibrating feeder apparatus of the present invention may be used with any suitable aggregate material processor.

Thus, the present invention also extends to aggregate processing plant comprising a mobile chassis having a main frame and an aggregate material processor, wherein the feed for the aggregate material processor is provided by an aggregate material vibrating feeder apparatus as defined herein.

Such aggregate processing plants include crushers such as such as jaw crushers, impact crushers, cone crushers, screening units such as ‘vibrating screening units’, feeder hopper systems for conveyors, separation and sorting units such as density separators and magnetic separators, and recycling units such as shredders.

The present invention may also be used in combination with any aggregate material pre-screening unit or apparatus, generally intended to also assist with preparing the pre-processed aggregate material prior to the aggregate material processor. Such screening units or apparatus can include one or more screens able to help separate or distinguish mixed materials, such as grizzly feeders, and often incorporation bar sections to screen out ‘fines’ in the material before processing.

Optionally, the aggregate material vibrating feeder apparatus includes a pre-screening apparatus.

In another arrangement, the present invention includes an aggregate material vibrating feeder assembly comprising an aggregate material vibrating feeder apparatus as defined herein, and an attached screening unit for screening the aggregate material provided by the aggregate material discharge outlet of the aggregate material vibrating feeder apparatus. Typically, the screening unit is a pre-screening unit.

Optionally, the screening unit comprises a first grid of elongate fixed longitudinal bars, and a second grid of elongate moveable longitudinal bars interspaced with the fixed longitudinal bars, wherein the second grid is directly driven in use in an eccentric motion relative to the first grid.

The screening unit is able to screen some of the feed material, to pre-remove material not desired or required to be crushed by the subsequent processing action of the aggregate material processor. Typical material removed by a screening unit can be dirt, or loose material, or ‘fines’. Such material can pass by gravity, and/or by positive action of the screening unit, towards a suitable collection location of area, such as a suitable collection tray, or an inlet end of a suitable conveyor able to convey such material away from the crusher.

Optionally, the second grid is driven by a drive motor. In this way, the direct driving of the second grid actively serves to keep the material being screened ‘moving along’ or across the screening area, and the eccentric driven motion of the second grid of bars relative to the first grid of bars actively forces the differential or out of phase or multi-mode motion thereinbetween, to maximise the prevention of clogging and pegging between the bars of the first and second grids. This positive driving force especially helps in relation to heavy-duty screens, which are typically being vibrated as well, to maximise the screening function of heavy materials, such as rubble and building wastes from demolition sites, etc., as mentioned above.

Optionally, the upper portions of the fixed longitudinal bars and the upper portions of the moveable longitudinal bars form one or more than one levels along the length of the screening unit. Where the upper portions of the fixed longitudinal bars and the upper portions of the moveable longitudinal bars have one level, the top of the screening unit can be considered as wholly or substantially flat. Where the upper portions of the fixed longitudinal bars and the upper portions of the moveable longitudinal bars have more than one level or tier, they can form a number or series of steps along the length of the screening unit, such that there is a drop in height of the material being screened along the length of the screening unit.

Optionally, the elongate moveable longitudinal bars are securely attached to the first grid via a flexible joint or transverse plate. The flexible joint of transverse plate may be located below the fixed and moveable longitudinal bars. The flexible joint or transverse plate may be of any suitable flexible unit or material, able to accept the eccentric motion of the other ends of the moveable longitudinal bars, and accommodate such motion relative to the fixed nature of the first grid. The transverse plate made be made from any suitable material or combination of materials, including metal, hard rubber, hard plastic, etc.

Optionally, the second grid further comprises a supporting framework extending beneath the fixed and moveable longitudinal bars. The framework may have any suitable shape and design, which allows the first grid to be positioned in a complementary manner. The framework has a have a series of slots or gaps, through which the bars of the first grid can be located in use.

Optionally, the second grid is driven by a drive motor. Such drive motor may be a dedicated drive motor. Such motor may be supported by a frame, optionally a frame supporting the first grid.

Optionally, the second grid is driven by an eccentric shaft of the drive motor in any eccentric, i.e. non-circular manner, such as elliptical. The eccentric drive may have any suitable shape, typically a non-circular cross-sectional shape such as elliptical, or a shaft having one or more shapes around its circumference, in order to create an eccentric motion for the second grid.

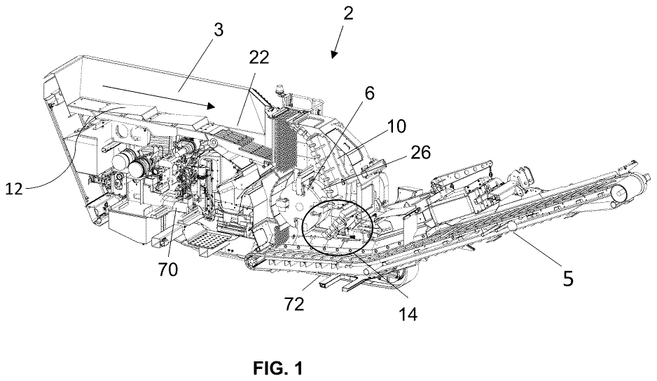

Referring to the drawings, FIG. 1 shows example embodiments of an aggregate processing plant comprising a mobile chassis having a main frame and an aggregate material processor, the plant having a aggregate material vibrating feeder assembly comprising an aggregate material vibrating feeder apparatus for receiving and conveying pre-processed aggregate material to an aggregate material processor, the feeder apparatus comprising a tray floor, an aggregate material discharge outlet, and a vibrating mechanism able to vibrate the apparatus to convey aggregate material along the tray floor towards the discharge outlet, wherein the tray floor comprises one or more ramped surfaces, and an attached screening unit for screening the aggregate material provided by the aggregate material discharge outlet of the aggregate material vibrating feeder apparatus, the screening unit comprising a first grid of elongate fixed longitudinal bars, and a second grid of elongate moveable longitudinal bars interspaced with the fixed longitudinal bars, wherein the second grid is directly driven in use in an eccentric motion relative to the first grid.

FIG. 1 shows an impact crusher having an impact crusher assembly 2. The impact crusher also comprises a feeder apparatus 3 with two ramped surfaces 12 described in more detail hereinafter, a plurality of blow bars mounted on a rotor core 6 and able to rotate about an axis, a primary impact plate 10 co-operating with the blow bars, and optionally a secondary impact plate 14 located below the primary impact plate 10. The impact crusher and impact crusher assembly 2 are mounted on a chassis 70, having a tracked wheel arrangement 72 to be mobile. The feeder apparatus 3 includes a screening unit 22. Crushed or processed material passes outwardly along one or more suitable conveyors 5 in a manner known in the art.

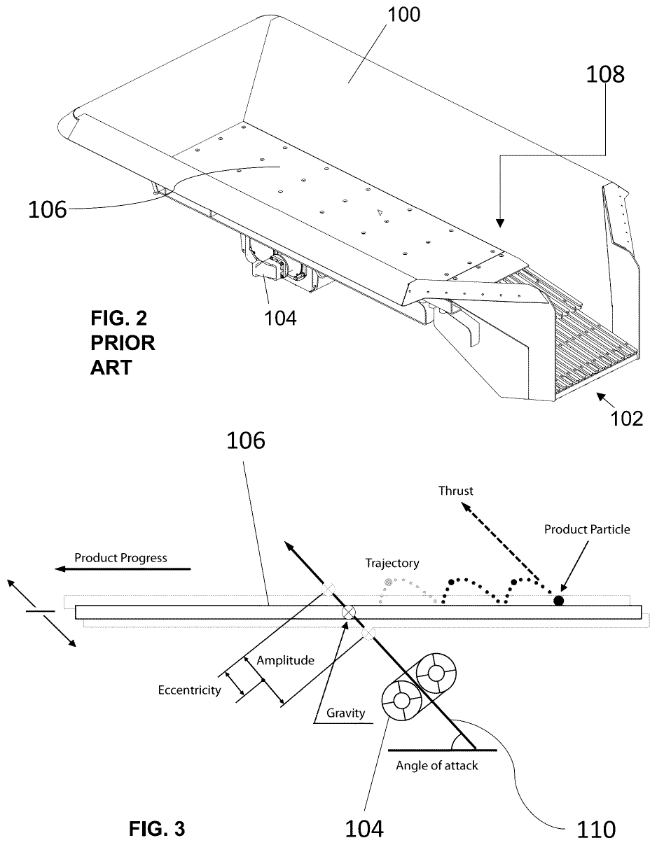

FIG. 2 shows a conventional hopper unit 100, a screening unit 102 at one end, and a vibration unit 104. The hopper unit 100 can be seen to have a flat floor 106, and the vibration unit 104 applies vibratory motion to the floor 106 which causes materials to ‘hop’ along the surface of the floor 106 in a sawtooth-like throw trajectory towards a discharge end 108 of the hopper unit 100, and then across a screening unit 102, and then towards the aggregate material processor (not shown), in a manner known in the art.

FIG. 3 shows the angle of attack 110 applied to the floor 106 by the vibration unit 104, and the trajectory of a “product particle” as a result. Conventionally, vibration units 104 are built into hopper units 100 to provide an angled and forward ‘thrust’ at, for example, an angle of 35°. For convenience, FIG. 3 shows this angle as relative to a flat or horizontal hopper floor 106. As the vibration unit 104 is built to be secured to the base of the hopper unit 100, the angle of attack is fixed.

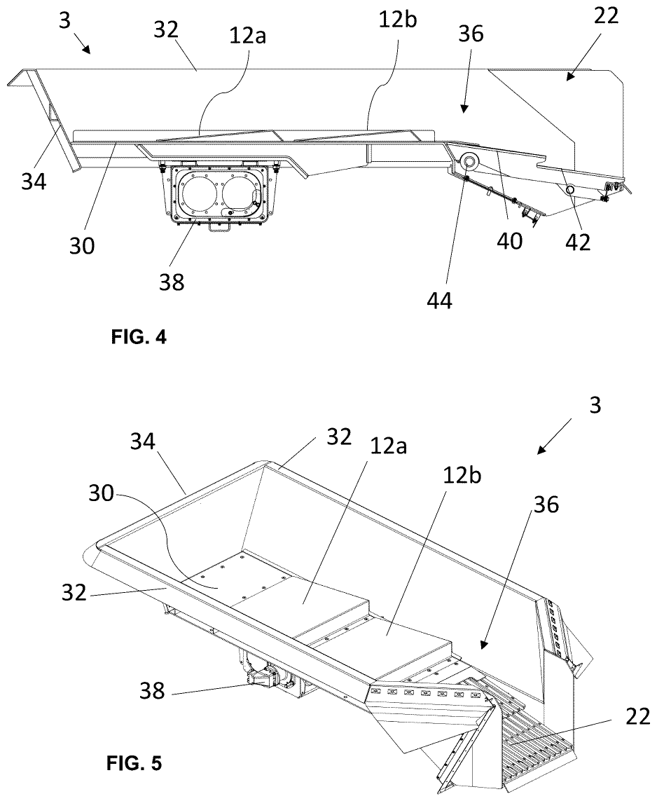

FIGS. 4 and 5 show a simplified and cross-sectional view and perspective view respectively of the aggregate material vibrating feeder assembly of FIG. 1, comprising the feeder apparatus 3 and screening unit 22. The feeder apparatus 3 comprises a tray floor 30, a side wall 32 on each side and an end wall 34 extending from the tray floor 30, an aggregate material discharge outlet 36, and a vibrating mechanism 38 able to vibrate the apparatus 3 to convey aggregate material along the tray floor 30 towards the discharge outlet 36.

The tray floor 30 comprises one or more ramped surfaces, being in this embodiment two ramps labelled 12a and 12b providing the ramped surfaces on the tray floor 30. The attached screening unit 22 is for screening the aggregate material provided at or by the aggregate material discharge outlet 36, and comprises a first grid of elongate fixed longitudinal bars 40, and a second grid of elongate moveable longitudinal bars 42 interspaced with the fixed longitudinal bars 40, wherein the second grid is directly driven in use in an eccentric motion relative to the first grid by a direct drive unit 44.

FIGS. 4 and 5 show each ramp 12a, 12b having a majority portion forming a first longer surface changing the angle from the tray floor 30 of the feeder apparatus 3, and a second surface thereafter forming a shorter second surface returning to the level of the tray floor 30. The ramps 12a, 12b form a series of steps along the path of the tray floor 30 towards the discharge outlet 36. The steps may be the same or different, and may be regular or irregular, and may be consecutive or discrete as discussed herein.

Where the ramps 12a, 12b are discrete components that may be removably attached to the feeder tray, one or both of the ramps 12a, 12b may be interchangeable to allow adjustment of the angle of attack by replacing one ramp with another having a different geometry. This could depend on the aggregate material mixture or ‘type’ to be processed, or desired flow behaviour. In this way, the present invention can enable modification of the tray floor 30 to suit different material handling requirements without altering the underlying structure or the vibratory mechanism 38.

The ramps 12a, 12b enable alteration of the progress or trajectory of pre-processed aggregate material along the feeder apparatus 3. By changing the angle of tray floor 30 relative to the angle of attack as discussed hereinafter in more detail, the angle at which vibratory force from the vibrating mechanism 38 is applied to the tray floor 30, a more consistent or regular volume and/or amount of material reaching the discharge outlet 36 can be achieved. The ramps 12a, 12b decrease the effective angle of attack experienced by the material, thereby reducing material velocity and improving metering accuracy to the aggregate material processor.

FIGS. 4 and 5 show two regularly shaped ramps 12a, 12b in series, each ramp 12a, 12b being the same height, and extending across the width of the feeder apparatus 3. The skilled reader can see that the number and shape and design of the ramped surfaces can be varied from the embodiment shown in FIGS. 4 and 5.

Optionally, each ramp 12a, 12b has an angle of inclination relative to the tray floor of between >0° and 60°. Optionally, each ramp 12 a, 12 b has a constant angle of inclination relative to the tray floor. Optionally, each ramp 12a, 12b is the same cross-section.

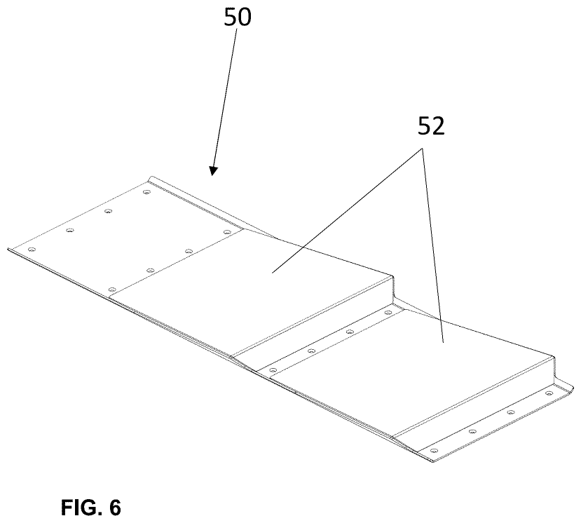

FIG. 6 shows an insert 50 for a feeder apparatus of the present invention having two ramped surfaces 52, that can be temporarily or permanently attached using bolts or similar, or otherwise integrated into the feeder tray for example by welding. The skilled reader can see that the number and shape and design of the ramped surfaces on or as part of such an insert can be varied from FIG. 6 for other purposes and/or other pre-processed aggregate materials.

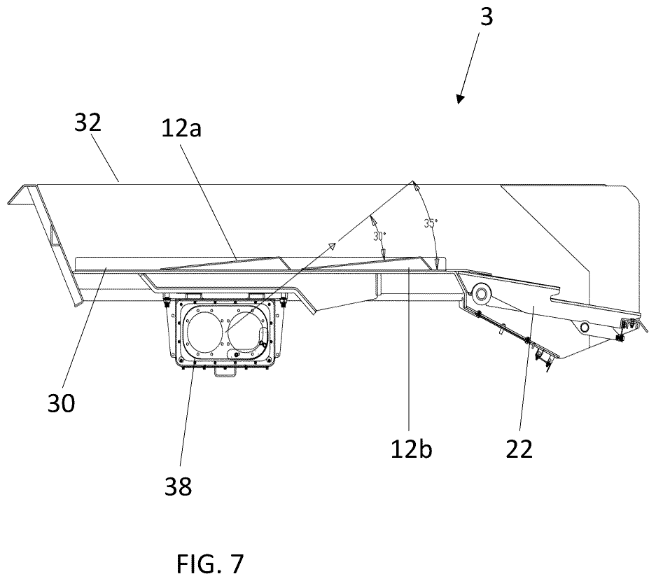

FIG. 7 shows a side cross-sectional schematic drawing of the feeder apparatus 3 of FIGS. 4 and 5, showing in particular the change of angle of attack from the 35° shown relative to the level of the tray floor 30, to a reduced angle of 30° relative to the level of the first side or majority portion of the second ramp 12b. The lower angle of attack results in slower, more controlled material movement, suitable for metering or fine feed control. A different incline or shape of the second ramp 12b would result in a different change in angle of attack. The first ramp 12a could provide the same or a different change in angle of attack. For example, having different inclines in the first ramp 12a and the second ramp 12b could provide a speed of trajectory that better suits overall flow of the material from a ‘loading end’ or other loading position, to the final discharge outlet 36.

The present invention provides a simple, modular, and field-adaptable apparatus and method that enables modification of the effective angle of attack on a vibrating feeder tray to suit different material handling requirements, without altering the underlying structure or vibratory mechanism. For example, in applications where it is desirable to reduce the flow rate at specific locations along the tray, particularly at the discharge end, the apparatus and method can enable targeted control of the material speed and behaviour. With suitable trials, an optimal angle of attack can be found for any pre-processed aggregate material to best achieve a regular and controlled discharge of material from the feeder.

1. An aggregate material vibrating feeder apparatus for receiving and conveying pre-processed aggregate material to an aggregate material processor, the feeder apparatus comprising a tray floor, an aggregate material discharge outlet, and a vibrating mechanism able to vibrate the apparatus to convey aggregate material along the tray floor towards the discharge outlet, wherein the tray floor comprises one or more ramped surfaces.

2. The aggregate material vibrating feeder apparatus as claimed in claim 1, wherein the one or more of the ramped surfaces are formed by one or more ramps.

3. The aggregate material vibrating feeder apparatus as claimed in claim 1, wherein the one or more ramp are is either integral with the tray floor, or is temporally secured to the tray floor, or a combination of same.

4. The aggregate material vibrating feeder apparatus as claimed in claim 1, wherein at least one or more ramped surfaces comprises one or more differently inclined surfaces.

5. The aggregate material vibrating feeder apparatus as claimed in claim 1, wherein at least one ramped surface comprises a variable inclined surface.

6. The aggregate material vibrating feeder apparatus as claimed in claim 1, wherein at least one ramped surface is located at or near the aggregate material discharge outlet.

7. The aggregate material vibrating feeder apparatus as claimed in claim 1, wherein at least one ramped surface has an angle of inclination relative to the tray floor of between 1° and 10°.

8. The aggregate material vibrating feeder apparatus as claimed in claim 1, wherein the surface of at least one ramped surface includes a replaceable wear liner on at least its inclined surface.

9. The aggregate material vibrating feeder apparatus as claimed in claim 1, comprising at least two ramped surfaces extending across the width of the tray floor.

10. The aggregate material vibrating feeder apparatus as claimed in claim 1, wherein the feeder apparatus is a hopper.

11. The aggregate material vibrating feeder apparatus as claimed in claim 1, further comprising one or more side walls.

12. The aggregate material vibrating feeder apparatus as claimed in claim 1, wherein the tray floor is wholly or substantially elongate and flat, the feeder apparatus further comprises two inclined side walls and a conjoined inclined end wall, and wherein the aggregate material discharge outlet is another end of the tray floor without any side wall.

13. The aggregate material vibrating feeder apparatus as claimed in claim 1, wherein the vibrating mechanism is an eccentric drive mechanism, wherein the eccentric drive mechanism applies an eccentric motion to the apparatus to convey aggregate material along the tray floor towards the discharge outlet.

14. (canceled)

15. (canceled)

16. (canceled)

17. (canceled)

18. An aggregate material vibrating feeder assembly comprising an aggregate material vibrating feeder apparatus for receiving and conveying pre-processed aggregate material to an aggregate material processor, the feeder apparatus comprising a tray floor, an aggregate material discharge outlet, and a vibrating mechanism able to vibrate the apparatus to convey aggregate material along the tray floor towards the discharge outlet, wherein the tray floor comprises one or more ramped surfaces, and
an attached screening unit for screening the aggregate material provided by the aggregate material discharge outlet of the aggregate material vibrating feeder apparatus, the screening unit comprising a first grid of elongate fixed longitudinal bars, and a second grid of elongate moveable longitudinal bars interspaced with the fixed longitudinal bars, wherein the second grid is directly driven in use in an eccentric motion relative to the first grid.

19. The aggregate material vibrating feeder assembly as claimed in claim 18, wherein the second grid is driven by a drive motor.

20. An aggregate processing plant comprising a mobile chassis having a main frame and an aggregate material processor, wherein the feed for the aggregate material processor is provided by an aggregate material vibrating feeder apparatus for receiving and conveying pre-processed aggregate material to an aggregate material processor, the feeder apparatus comprising a tray floor, an aggregate material discharge outlet, and a vibrating mechanism able to vibrate the apparatus to convey aggregate material along the tray floor towards the discharge outlet, wherein the tray floor comprises one or more ramped surfaces.

21. The aggregate processing plant as claimed in claim 20, wherein the aggregate processing plant is a crusher.

22. The aggregate processing plant as claimed in claim 20, wherein the one or more of the ramped surfaces are formed by one or more ramps.

23. The aggregate processing plant as claimed in claim 20, wherein the or each ramp is either integral with the tray floor, or is temporally secured to the tray floor, or a combination of same.

24. The aggregate processing plant as claimed in claim 20, wherein the tray floor is wholly or substantially elongate and flat, wherein the feeder apparatus further comprises two inclined side walls and a conjoined inclined end wall, the aggregate material discharge outlet is another end of the tray floor without any side wall, and the vibrating mechanism is an eccentric drive mechanism, wherein the eccentric drive mechanism applies an eccentric motion to the apparatus to convey aggregate material along the tray floor towards the discharge outlet.
